(19) United States
(12) Patent Application Publication
(10) Pub. No.: US 2015/0089967 A1
(43) Pub. Date: Apr. 2, 2015

(54) HEAT PUMP SYSTEM FOR VEHICLE

(71) Applicant: Hyundai Motor Company, Seoul (KR)

(72) Inventors: Young Jun Kim, Suwon-si (KR); Kilwoo Lee, Seoul (KR)

(73) Assignee: Hyundai Motor Company, Seoul (KR)

(21) Appl. No.: 14/138,749

(22) Filed: Dec. 23, 2013

(30) Foreign Application Priority Data
Sep. 27, 2013 (KR) 10-2013-0115597

(51) Int. Cl. B60H 1/00

(52) U.S. Cl. CPC B60H 1/00007
USPC 62/238.6

(57) ABSTRACT

A heat pump system includes air conditioning devices to adjust operations of cooling and heating a vehicle interior by circulating a refrigerant in accordance with a heating mode and a cooling mode of an electric vehicle, includes an outdoor condenser configured to condense the refrigerant, an expansion valve configured to expand the refrigerant condensed by the outdoor condenser, an evaporator configured to evaporate the refrigerant expanded by the expansion valve, a compressor configured to compress the refrigerant evaporated by the evaporator, and an indoor condenser configured to primarily condense the refrigerant compressed by the compressor and connected to the outdoor condenser. The heat pump system may further include: a radiator connected to electronic equipment; a chiller configured integrally with the radiator; first connecting piping connecting the refrigerant piping and the chiller; and second connecting piping connecting the refrigerant from the chiller to the refrigerant piping.

### CROSS-REFERENCE TO RELATED APPLICATION

The present application claims priority of Korean Patent Application Number 10-2013-0115597 filed Sep. 27, 2013, the entire contents of which application is incorporated herein for all purposes by this reference.

### BACKGROUND OF INVENTION

1. Field of Invention

The present invention relates to a heat pump system for a vehicle, and more particularly, to a heat pump system for a vehicle in which a water cooling type chiller is integrally configured with a radiator, and a refrigerant selectively passes through the chiller in accordance with a heating mode or a cooling mode of a vehicle, thereby improving overall efficiency of a system, shortening a piping length, and simplifying constituent elements.

2. Description of Related Art

In general, an air conditioner for a vehicle includes an air conditioning module for cooling and heating an interior of the vehicle.

In a process in which a heat exchange medium discharged by an operation of a compressor passes through a condenser, a receiver dryer, an expansion valve, and an evaporator, and then circulates back to the compressor, the air conditioning module is configured to cool the interior of the vehicle through heat exchange by the evaporator, or heat the interior of the vehicle by allowing the coolant to flow into a heater so as to exchange heat with the heater.

Meanwhile, recently, as a concern about energy efficiency and environmental pollution problems has gradually increased, development of an environmentally-friendly vehicle capable of being substantially substituted for a vehicle having an internal combustion engine is required, and the environmentally-friendly vehicles are typically classified into an electric vehicle which is driven typically using a fuel cell or electricity as a power source, and a hybrid vehicle which is driven using an engine and an electric battery.

In the electric vehicle, among the environmentally-friendly vehicles, a separate heater is not used unlike an air conditioner of a general vehicle, and an air conditioner, which is applied to the electric vehicle, is typically referred to as a heat pump system.

In the heat pump system, when a cooling mode is performed in the summer season, the general principle in which a gaseous refrigerant in a high temperature and high pressure state, which is compressed by the compressor, is condensed by the condenser, passes through the receiver dryer and the expansion valve, and then is evaporated in the evaporator so as to lower indoor temperature and humidity is identically applied. However, in contrast, the heat pump system has a feature in that when a heating mode is performed in the winter season, a gaseous refrigerant in a high temperature and high pressure state is used as a heating medium.

That is, in the heating mode of the electric vehicle, the gaseous refrigerant in a high temperature and high pressure state does not flow into an outdoor condenser but flows into an indoor condenser through a valve, and exchanges heat with air sucked from the outside. Further, the outside air, which has exchanged heat with the refrigerant, flows into the interior of the vehicle while passing through a positive temperature coefficient (PTC) heater, thereby increasing an indoor temperature of the vehicle.

Further, the gaseous refrigerant in a high temperature and high pressure state, which flows into the indoor condenser, is condensed by heat exchange with the sucked outside air, and then discharged again as a liquid refrigerant.

However, since the aforementioned heat pump system of the related art adopts an air cooling type in which outside air is used as a heat exchange medium for exchanging heat with a refrigerant, structures of heat exchangers including the compressor and structures of respective constituent elements are complicated, lengths of piping that connects the respective constituent elements are increased, and thereby, there is a problem in that an overall system package is complicated.

Because a heat source is not sufficient to convert the liquid refrigerant into the gaseous refrigerant when the liquid refrigerant is sucked into the compressor from the outdoor condenser, there are problems in that compression efficiency deteriorates, heating performance is significantly degraded when an outside air temperature is low, a system is unstable, and durability of the compressor deteriorates when the liquid refrigerant flows into the compressor.

In addition, since a heating operation needs to be performed with only the PTC heater, there are also problems in that heating performance greatly deteriorates, a travel distance is shortened by an increase in heating load due to an increase in amount of power consumption, and travel performance deteriorates because of a malfunction of the entire system when the heat exchanger or the valve is damaged.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for a heat pump system for a vehicle in which a water cooling type chiller is integrally configured with a radiator in which a coolant circulates, and a refrigerant selectively passes through the chiller in accordance with a heating mode or a cooling mode of a vehicle, such that piping and valves between the chiller and the radiator may be eliminated so as to shorten the overall piping length and simplify constituent elements, thereby reducing costs, improving package performance, and improving overall efficiency of a system by using a waste heat source.

Various aspects of the present invention provide for a heat pump system for a vehicle including air conditioning means which are connected to each other through refrigerant piping so as to adjust operations of cooling and heating an interior of a vehicle by circulating a refrigerant in accordance with a heating mode and a cooling mode of an electric vehicle, and includes an outdoor condenser configured to condense the refrigerant, an expansion valve configured to expand the refrigerant condensed by the outdoor condenser, an evaporator configured to evaporate the refrigerant expanded by the expansion valve, a compressor configured to compress the refrigerant evaporated by the evaporator, and an indoor condenser configured to primarily condense the refrigerant compressed by the compressor and connected to the outdoor condenser, the heat pump system further including: a radiator connected to electronic equipment through coolant piping and configured to cool a coolant having a temperature raised by cooling the electronic equipment, using heat exchange with outside air; a chiller configured integrally with the radiator, connected to the refrigerant piping, and configured to exchange heat between the coolant and the refrigerant; first connecting piping configured to connect the refrigerant piping and the chiller to each other between the outdoor condenser and the expansion valve; and second connecting piping configured to connect the refrigerant discharged from the chiller to the refrigerant piping disposed between the evaporator and the compressor.

The first connecting piping may be connected to the refrigerant piping, which connects the outdoor condenser and the expansion valve to each other, through a valve.

The valve may be a 3-way valve.

The second connecting piping may be connected to an accumulator provided between the evaporator and the compressor.

The refrigerant piping may further include an orifice provided between the outdoor condenser and the indoor condenser.

In the heating mode, the coolant having a temperature raised by a waste heat source when cooling the electronic equipment may flow into the radiator through the chiller, and the refrigerant flowing into the chiller through the first connecting piping from the outdoor condenser and having a temperature raised by heat exchange with the coolant having a raised temperature may flow into the refrigerant piping between the evaporator and the compressor.

In the cooling mode, the first connecting piping may be closed so as to prevent the refrigerant from flowing into the chiller, and the refrigerant discharged from the outdoor condenser may flow into the expansion valve.

The water cooling type chiller may be integrally configured with the radiator in which the coolant circulates, and the refrigerant selectively passes through the chiller in accordance with the heating mode or the cooling mode of the vehicle, such that piping and valves between the chiller and the radiator may be eliminated so as to shorten the overall piping length and simplify constituent elements, thereby reducing costs, and improving package performance.

In addition, a pressure loss is prevented by shortening the piping length and eliminating valves for adjusting a flow of the coolant such that cooling performance is improved. Moreover, noise is prevented from being generated when the valves are operated, and heating performance is improved by using a waste heat source, thereby improving overall efficiency of the system.

In addition, the radiator and the chiller are integrally configured, thereby simplifying a piping layout in a narrow engine compartment, and improving spatial utilization.

In addition, unnecessary electricity consumption is prevented by improving overall efficiency of the system, thereby increasing a travel distance.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block configuration view of an exemplary heat pump system for a vehicle according to the present invention.

FIG. 2 is a view illustrating an operation state of a heating mode of an exemplary heat pump system for a vehicle according to the present invention.

FIG. 3 is a view illustrating an operation state of a cooling mode of an exemplary heat pump system for a vehicle according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Throughout the specification and the claims, unless explicitly described to the contrary, the word “comprise” and variations such as “comprises” or “comprising” will be understood to imply the inclusion of stated elements but not the exclusion of any other elements.

In addition, “unit”, “means”, “part”, “member”, or the like, which is described in the specification, means a unit of a comprehensive configuration that performs at least one function or operation.

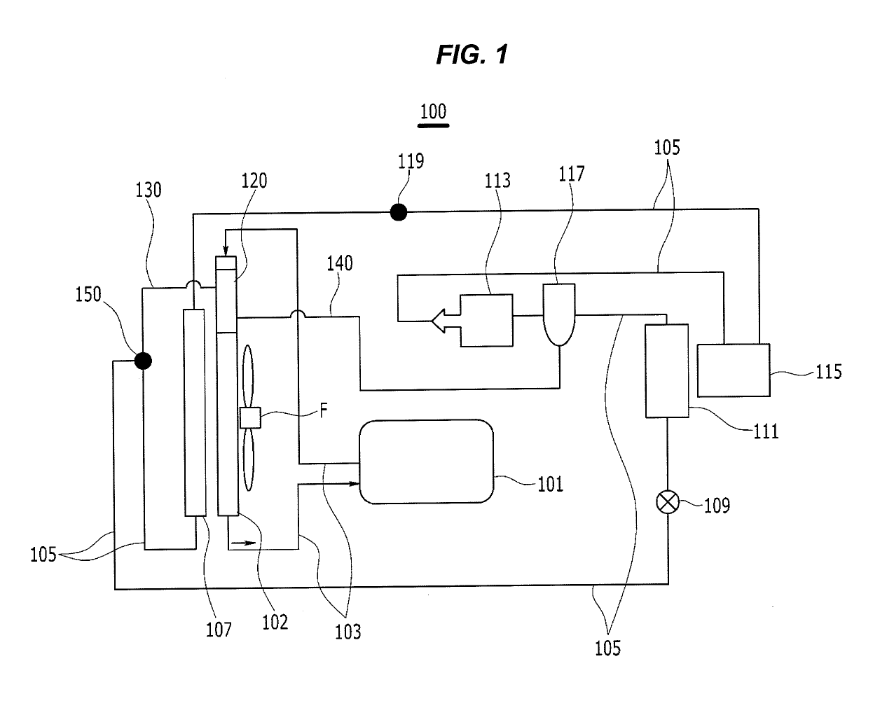

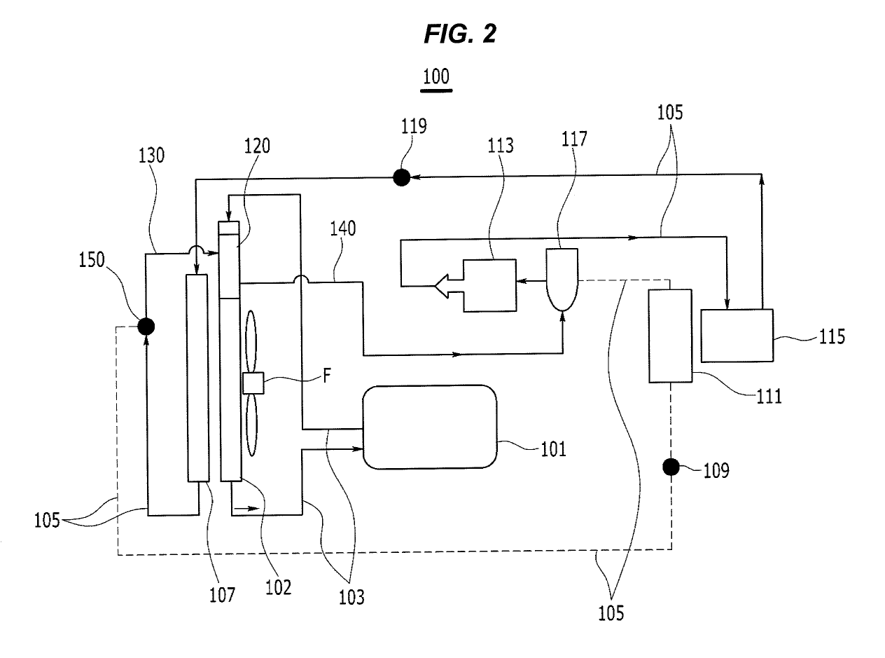

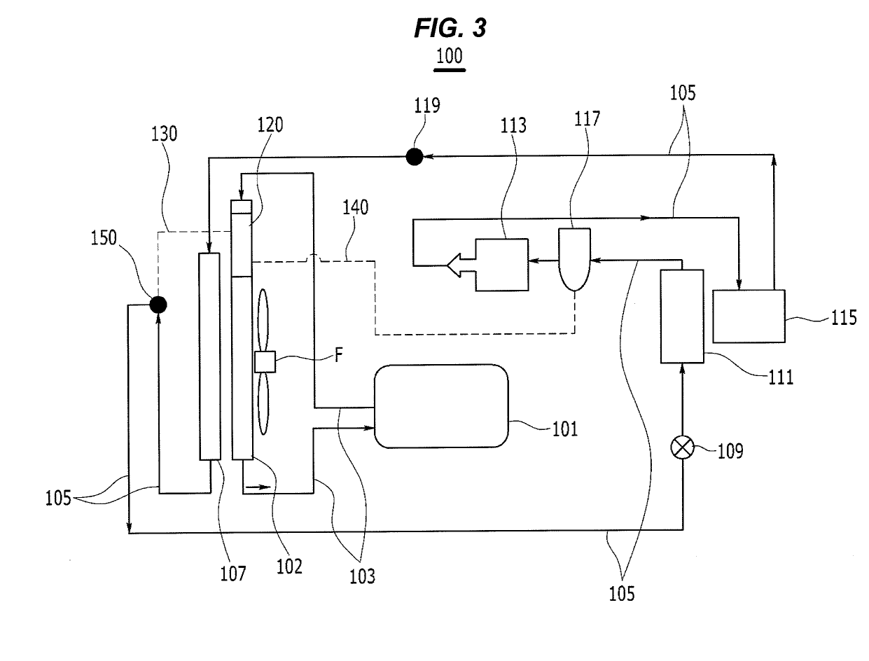

FIG. 1 is a block configuration view of a heat pump system for a vehicle according to various embodiments of the present invention, FIG. 2 is a view illustrating an operation state of a heating mode of the heat pump system for a vehicle according to various embodiments of the present invention, and FIG. 3 is a view illustrating an operation state of a cooling mode of the heat pump system for a vehicle according to various embodiments of the present invention.

Referring to the drawings, a heat pump system 100 for a vehicle according to various embodiments of the present invention is applied to an electric vehicle, and has a structure in which a water cooling type chiller 120 is integrally configured with a radiator 102 in which a coolant for cooling electronic equipment 101 in the electric vehicle circulates, and a refrigerant selectively passes through the chiller 120 in accordance with a heating mode or a cooling mode of the vehicle, such that piping and valves between the chiller 120 and the radiator 102 may be eliminated so as to shorten the overall piping length and simplify constituent elements, thereby reducing costs, improving package performance, and improving overall efficiency of a system by using a waste heat source.

To this end, as illustrated in FIG. 1, the heat pump system 100 for a vehicle according to various embodiments of the present invention includes air conditioning devices or other suitable means which are connected to each other through refrigerant piping 105 so as to adjust operations of cooling and heating an interior of the vehicle by circulating a refrigerant in accordance with the heating mode and the cooling mode of the electric vehicle, and includes an outdoor condenser 107, an expansion valve 109, an evaporator 111, a compressor 113, and an indoor condenser 115.

In the air conditioning means, the outdoor condenser 107 is disposed at a front side of the vehicle and condenses the refrigerant by heat exchange with outside air, and the expansion valve 109 is supplied with the refrigerant condensed by the outdoor condenser 107 and expands the refrigerant.

Further, the evaporator 111 is supplied with the refrigerant expanded by the expansion valve 109 and evaporates the refrigerant, the compressor 113 is supplied with the refrigerant evaporated by the evaporator 109 and compresses the refrigerant, and the indoor condenser 115 primarily condenses the refrigerant compressed by the compressor 113 and is connected to the outdoor condenser 107.

The heat pump system 100 for a vehicle according to various embodiments of the present invention includes a radiator 102, a chiller 120, first connecting piping 130, and second connecting piping 140.

First, the radiator 102 is disposed at the front side of the vehicle and at a rear side of the outdoor condenser 107, is connected to the electronic equipment 101 through coolant piping, and cools the coolant having a temperature raised by cooling the electronic equipment 101, by heat exchange with the outside air.

A cooling fan F, which blows air together with the outside air to the radiator 102 and the outdoor condenser 107, may be mounted at a rear side of the radiator 102.

In various embodiments, the chiller 120 is integrally configured with the radiator 102, and is connected to the refrigerant piping 105 so as to exchange heat between the coolant and the refrigerant.

That is, the chiller 120 may be configured as a water cooling type heat exchanger in which a coolant is used as a heat exchange medium for exchanging heat with a refrigerant.

In various embodiments, the first connecting piping 130 connects the refrigerant piping 105 and the chiller 120 to each other between the outdoor condenser 107 and the expansion valve 109.

Here, the first connecting piping 130 may be connected to the refrigerant piping 105, which connects the outdoor condenser 107 and the expansion valve 109 to each other, through a valve 150.

Each valve 150 may be a 3-way valve, and therefore, the refrigerant condensed while passing through the outdoor condenser 107 flows into the chiller 120 through the first connecting piping 130, or flows into the expansion valve 109 through the refrigerant piping 105 without passing through the chiller 120.

Further, the second connecting piping 140 connects the refrigerant discharged from the chiller 120 to the refrigerant piping 105 disposed between the evaporator 111 and the compressor 113.

Here, the second connecting piping 140 may be connected to an accumulator 117 that is provided between the evaporator 111 and the compressor 113 and supplies only gaseous refrigerant to the compressor 113.

Accordingly, the accumulator 117 separates liquid refrigerant included in the refrigerant passing through the chiller 120 or in the gaseous refrigerant flowing into the compressor 113 after passing through the evaporator 111, supplies the gaseous refrigerant to the compressor 113, stores the liquid refrigerant in the accumulator 117, evaporates the liquid refrigerant, and then supplies again only the gaseous refrigerant to the compressor 113, thereby preventing failure and a malfunction of the compressor 113, and improving efficiency and durability.

Meanwhile, in various embodiments, the refrigerant piping 105 may further include an orifice 119 provided between the outdoor condenser and the indoor condenser.

Hereinafter, an operation and an action in accordance with the heating mode and the cooling mode of the heat pump system 100 for a vehicle according to various embodiments of the present invention, which is configured as described above, will be described in detail.

First, as illustrated in FIG. 2, in the heating mode of the vehicle, the coolant having a temperature raised by a waste heat source when cooling the electronic equipment 101 circulates in the heat pump system 100 while flowing into the radiator 102 through the chiller 120, and then being supplied back to the electronic equipment 101 after being cooled by heat exchange with the outside air.

Here, the valve 150 opens the first connecting piping 130 so that the refrigerant condensed while passing through the outdoor condenser 107 is supplied to the chiller 120, and maintains the refrigerant piping 105, which is connected to the expansion valve 109, in a closed state.

Then, the refrigerant is condensed to be in a low temperature and low pressure state by heat exchange with the outside air while passing through the outdoor condenser 107, and then flows into the chiller 120 through the first connecting piping 130.

Accordingly, the refrigerant flowing into the chiller 120 and having a temperature raised by heat exchange with the coolant having a raised temperature flows into the compressor 113 via the accumulator 117 through the second connecting piping 140.

Then, the compressor 113 is supplied with the refrigerant having a raised temperature, compresses the refrigerant to produce gaseous refrigerant in a high temperature and high pressure state, and then supplies the gaseous refrigerant to the indoor condenser 115. In this case, because the indoor condenser 115 is provided in a non-illustrated HVAC (heating, ventilation, and air conditioning) module, the warm outside air having a temperature raised by passing through the indoor condenser 115 is supplied to the interior of the vehicle in conjunction with a selective operation of a non-illustrated PTC heater, thereby heating the interior of the vehicle.

Thereafter, the refrigerant of which heat is radiated by heat exchange with the outside air flowing into the interior of the vehicle after passing through the indoor condenser 115 is changed into the refrigerant in a low temperature and low pressure state while passing through the orifice 119, absorbs heat from the outside air while passing through the outdoor condenser 107, and then is supplied back to the chiller 120. Thus, the operation of heating the interior of the vehicle is performed by repeatedly performing the aforementioned operations.

Accordingly, in the heating mode of the vehicle, in conjunction with the operation of the PTC heater, the heat pump system 100 according to various embodiments allows the outside air, which has a temperature raised by passing through the indoor condenser 115 into which the gaseous refrigerant in a high temperature and high pressure state flows, to flow into the interior of the vehicle, such that the interior of the vehicle is heated, thereby preventing overload of the PTC heater so as to prevent excessive power from being consumed.

Further, as illustrated in FIG. 3, in the cooling mode of the vehicle, a valve 129, which connects the refrigerant piping 105 and the first connecting piping 119, closes the first connecting piping 119, and maintains the refrigerant piping 105 connected to the expansion valve 109 in an open state.

Accordingly, the refrigerant is condensed to be in a low temperature and low pressure state by heat exchange with the outside air while passing through the outdoor condenser 107, expanded while passing through the expansion valve 109, and then supplied to the compressor 113 via the accumulator 117 after passing through the evaporator 111.

The refrigerant discharged from the compressor 113 passes through the indoor condenser 115, passes again through the orifice 119 along the refrigerant piping 105, flows into the outdoor condenser 107, and thus circulates in the air conditioning means.

Here, the outside air flowing into the interior of the vehicle and having a temperature lowered by heat exchange with the refrigerant while passing through the indoor condenser 115 flows into the interior of the vehicle. Thus, the operation of cooling the interior of the vehicle is performed by repeatedly performing the aforementioned processes.

Here, the coolant, which cools the electronic equipment 101, continues to circulate to the chiller 120 while passing through the radiator 102, but as the first connecting piping 130 is closed by a closing operation of the valve 150, the refrigerant is prevented from flowing into the accumulator 117 through the second connecting piping 140.

That is, the heat pump system 100 according to various embodiments supplies the refrigerant having a temperature raised by passing through the chiller 120 to the compressor 113 in the heating mode of the vehicle, and prevents the refrigerant from passing through the chiller 120 in the cooling mode of the vehicle, thereby more efficiently heating or cooling the interior of the vehicle.

Therefore, when the heat pump system 100 for a vehicle according to various embodiments of the present invention, which is configured as described above, is applied, the water cooling type chiller 120 is integrally configured with the radiator 102 in which the coolant circulates, and the refrigerant selectively passes through the chiller 120 in accordance with the heating mode or the cooling mode of the vehicle, such that piping and valves between the chiller 120 and the radiator 102 may be eliminated so as to shorten the overall piping length and simplify constituent elements, thereby reducing costs, and improving package performance.

In addition, a pressure loss is prevented by shortening the piping length and eliminating valves for adjusting a flow of the coolant such that cooling performance is improved. Moreover, noise is prevented from being generated when the valves are operated, and heating performance is improved by using a waste heat source, thereby improving overall efficiency of the system.

In addition, the radiator 102 and the chiller 120 are integrally configured, thereby simplifying a piping layout in a narrow engine compartment, and improving spatial utilization.

In addition, unnecessary electricity consumption is prevented by improving overall efficiency of the system, thereby increasing a travel distance.

For convenience in explanation and accurate definition in the appended claims, the terms front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A heat pump system for a vehicle comprising:
air conditioning devices connected to each other through refrigerant piping to adjust operations of cooling and heating an interior of a vehicle by circulating a refrigerant in accordance with a heating mode and a cooling mode of an electric vehicle;
an outdoor condenser to condense the refrigerant;
an expansion valve configured to expand the refrigerant condensed by the outdoor condenser;
an evaporator configured to evaporate the refrigerant expanded by the expansion valve;
a compressor configured to compress the refrigerant evaporated by the evaporator;
an indoor condenser configured to primarily condense the refrigerant compressed by the compressor and connected to the outdoor condenser;
a radiator connected to electronic equipment through coolant piping and configured to cool a coolant having a temperature raised by cooling the electronic equipment, using heat exchange with outside air;
a chiller configured integrally with the radiator, connected to the refrigerant piping, and configured to exchange heat between the coolant and the refrigerant;
first connecting piping configured to connect the refrigerant piping and the chiller to each other between the outdoor condenser and the expansion valve; and
second connecting piping configured to connect the refrigerant discharged from the chiller to the refrigerant piping disposed between the evaporator and the compressor.

2. The heat pump system of claim 1, wherein the first connecting piping is connected to the refrigerant piping that connects the outdoor condenser and the expansion valve to each other by a valve.

3. The heat pump system of claim 2, wherein the valve is a 3-way valve.

4. The heat pump system of claim 1, wherein the second connecting piping is connected to an accumulator provided between the evaporator and the compressor.

5. The heat pump system of claim 1, wherein the refrigerant piping further includes an orifice provided between the outdoor condenser and the indoor condenser.

6. The heat pump system of claim 1, wherein in the heating mode, the coolant having a temperature raised by a waste heat source when cooling the electronic equipment flows into the radiator through the chiller, and the refrigerant flowing into the chiller through the first connecting piping from the outdoor condenser and having a temperature raised by heat exchange with the coolant having a raised temperature flows into the refrigerant piping between the evaporator and the compressor.

7. The heat pump system of claim 1, wherein in the cooling mode, the first connecting piping is closed to prevent the refrigerant from flowing into the chiller, and the refrigerant discharged from the outdoor condenser flows into the expansion valve.

8. A heat pump system for a vehicle comprising:
components are connected to each other through refrigerant piping in an electric vehicle to adjust operations of cooling and heating an interior of a vehicle by circulating a refrigerant in accordance with a heating mode and a cooling mode;
air conditioning devices connected to each other through the refrigerant piping and in which the refrigerant circulates while operations of condensing, compressing, and evaporating the refrigerant are repeatedly performed;
a radiator connected to electronic equipment through coolant piping and configured to cool a coolant having a temperature raised by cooling the electronic equipment, using heat exchange with outside air;
a chiller configured integrally with the radiator, connected to the electronic equipment through the coolant piping, connected to the refrigerant piping, and configured to exchange heat between the coolant and the refrigerant;
first connecting piping configured to connect the air conditioning devices and the chiller to each other and allow the refrigerant to flow into the chiller by an opening and closing operation of a valve in accordance with the heating mode or the cooling mode; and
second connecting piping configured to connect the refrigerant, which is discharged after exchanging heat with the coolant while passing through the chiller, to the air conditioning devices.

9. The heat pump system of claim 8, wherein:
the air conditioning devices are connected to each other through the refrigerant piping, and includes: an outdoor condenser configured to condense the refrigerant;
an expansion valve configured to expand the refrigerant condensed by the outdoor condenser;
an evaporator configured to evaporate the refrigerant expanded by the expansion valve;
a compressor configured to compress the refrigerant evaporated by the evaporator; and
an indoor condenser configured to primarily condense the refrigerant compressed by the compressor and connected to the outdoor condenser.

10. The heat pump system of claim 9, wherein the first connecting piping is connected to the refrigerant piping between the outdoor condenser and the expansion valve.

11. The heat pump system of claim 9, wherein the second connecting piping is connected to an accumulator provided on the refrigerant piping between the evaporator and the compressor so that the refrigerant discharged from the chiller is supplied to the compressor.

12. The heat pump system of claim 9, wherein in the heating mode, the coolant having a temperature raised by a waste heat source when cooling the electronic equipment flows into the radiator through the chiller, and the refrigerant flowing into the chiller through the first connecting piping from the outdoor condenser and having a temperature raised by heat exchange with the coolant having a raised temperature flows into the refrigerant piping between the evaporator and the compressor.

13. The heat pump system of claim 9, wherein in the cooling mode, the first connecting piping is closed to prevent the refrigerant from flowing into the chiller, and the refrigerant discharged from the outdoor condenser flows into the expansion valve.

14. The heat pump system of claim 8, wherein the valve is a 3-way valve.
